(19) United States
(12) Patent Application Publication
(10) Pub. No.: US 2003/0160365 A1
(43) Pub. Date: Aug. 28, 2003

(54) Method of manufacturing a composite panel

(76) Inventor: Bari W. Brown, Ann Arbor, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(21) Appl. No.: 10/085,370

(22) Filed: Feb. 28, 2002

(51) Int. Cl. B29C 39/12

(52) U.S. Cl. 264/553; 264/259

(57) ABSTRACT

A method of producing composite vehicle door panels. A skin is manufactured in a vacuum-forming mold. The skin is then transferred to a RIM mold. Next, natural fibers and an isocyanate and a resin mixture are placed on the skin. The isocyanate and resin mixture, the natural fiber, and the skin are then polymerized into a composite panel.

### BACKGROUND OF THE INVENTION

1. Field of the Invention

This invention relates to a method of manufacturing a composite panel, and in particular, a method of manufacturing a composite panel having natural fiber material.

2. Background Art

Panels are frequently placed in vehicles along the doors, instrument panel, consoles, and other components. Currently, panels are manufactured using a wide variety of methods and materials. For example, panels may be injection-molded out of a thermoplastic polymer. Also, panels may be compression-molded using a fiberglass reinforced material. However, the fiberglass in these systems is not 100% recyclable and there are perceived handling issues. Injection molding these panels may be cost-prohibitive and produce parts that do not have sufficient structural integrity.

Accordingly, there is a need for a method of manufacturing panels that is economical, eliminates perceived handling issues, produces parts having sufficient structural integrity, and produces 100% recyclable parts.

### SUMMARY OF THE INVENTION

The present invention overcomes the problems encountered in the prior art by providing a method of producing a composite panel that comprises manufacturing a skin in a vacuum-foam mold. The skin is then transferred to a RIM mold. Next, natural fibers and an isocyanate and a resin mixture are placed on the skin. The isocyanate and resin mixture, the natural fiber, and the skin are then polymerized into a composite panel.

In yet another embodiment of the invention, the skin is trimmed using a water jet cutter.

These and other advantages of the present invention will become apparent to one of ordinary skill in the art in light of the following description and attached drawings.

### BRIEF DESCRIPTION OF THE DRAWINGS

FIG. 1 is a perspective view of a composite vehicle door panel;

FIG. 2 is a perspective view of a vacuum-forming die and a blank;

FIG. 3 is a perspective view of a water jet trimming operation; and

FIG. 4 is a perspective view of the manufacturing process showing application of the isocyanate and resin mixture and the coverstock.

### DETAILED DESCRIPTION OF THE PREFERRED EMBODIMENT(S)

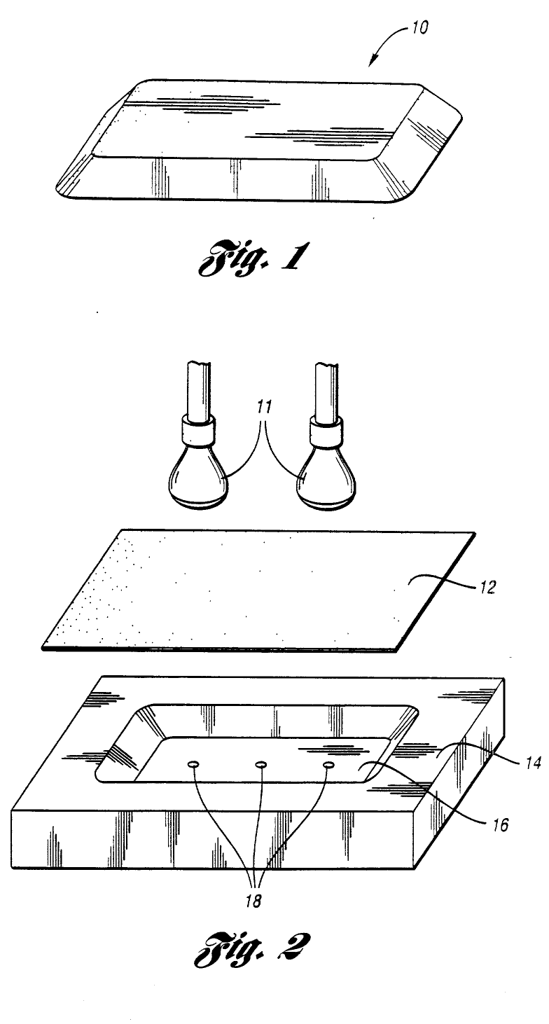

A finished vehicle door panel 10 is illustrated in FIG. 1. While the invention refers to and illustrates a door panel, the present invention is applicable to other vehicular panels and also non-automotive applications.

The final vehicle door panel 10 begins as a blank of material 12 as illustrated in FIG. 2. The blank may be made out of, for example, polyvinyl chloride, polypropylene, polyethylene, thermoplastic olefin, polyurethane, thermoplastic polyurethane, olefin, or blends of any of the above. The blank may be provided in either roll or sheet form or sprayed directly into a mold. Preferably, the blank is made out of polyvinyl chloride. The blank may also have a foam back to provide a slight cushion. Preferably, the blank is about 1 to 3 millimeters thick.

Prior to vacuum-forming, the blank 12 is softened using heating elements 11 which may be infrared heat lamps, exhaust ports for a heated gas, or other heating methods. The blank 12 is placed on a vacuum-forming die 14 having a cavity 16 essentially in the shape of the final desired part. The cavity 16 comprises a plurality of holes 18 used to draw the blank 12 into the cavity 16 so that the blank take its final form 20. Additionally, air pressure can be used to help form the part. A male die portion (not shown) can also be used to help form the part by pressing the blank into the cavity 16.

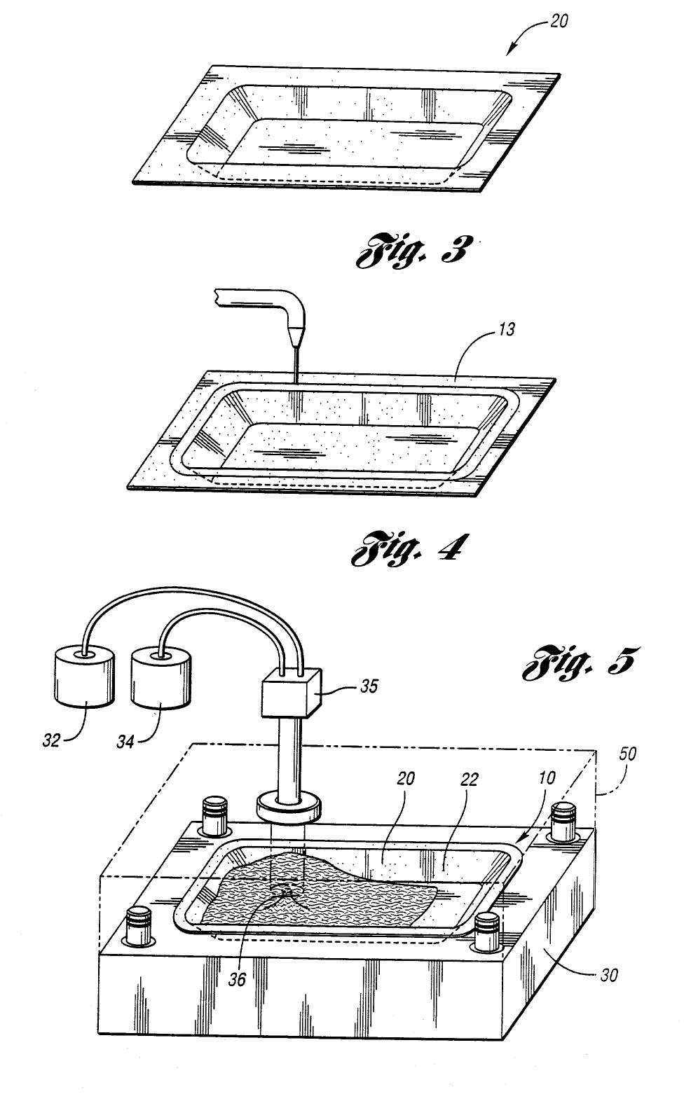

When the formed part or skin 20 has sufficiently cooled, it is removed from the vacuum-forming die 14. This step can be either done manually or using automated techniques such as robotics. At this point, excess material 13 can be trimmed from the formed part 20 using a trimming operation such as a water jet cutter as shown in FIG. 3. The water jet cutter uses water pressurized up to 60,000 psi and forced through a small opening to trim the excess material that creates the final desired part shape. Abrasive material, such as garnet, may be added to the pressurized water to better cut composite materials.

Referring now to FIG. 4, the formed part 20 is placed in a RIM mold cavity 30 having a cavity (not shown) essentially in the shape of the final part. The mold 30 heated to approximately 140-180 degrees Fahrenheit. Next, natural fibers 22 of, for example, hemp, kenaf, sisal, flax, or jute may be placed on the cut skin. As discussed below, the fibers may be applied simultaneously with the resin. These natural fibers 22 replace fiber glass and other fibers used in the prior art to provide recyclability. FIG. 4 illustrates the natural fibers 22 placed on an interior, concave surface. The natural fibers 22 may be provided as a fiber mat or as rovings. Further, the natural fibers 22 can be provided in roll or sheet form.

A male mold portion 50 then closes onto mold cavity 30. A gap is created between the formed part 20 and the male mold portion 50.

Isocyanate 32 and resin 34 are mixed in an impingement head 35 and the resulting isocyanate and resin mixture 36 is either applied into the gap created between the formed part 20 and the male mold portion 50 through a mixhead via the open pour process simultaneously with chopped natural fibers 22 or onto the natural fibers 22 and form part 20. Preferably, the isocyanate is polymeric isocyanate. More preferably, the isocyanate is a polymeric isocyanate having 30-34% free NCO. The resin mixture is preferably a rigid type formulation. However, one skilled in the art could substitute other isocyanate and resin mixtures.

Attachments, such as nylon hooks (not shown), may be put into the isocyanate and resin mixture 36 or attached to the formed part 20 to provide secure attachments for the part. The isocyanate and resin mixture 36, the natural fiber 22, and the skin 22 are then polymerized in to a composite vehicle panel.

At this point, the panel may need to be trimmed either again or for the first time. Similarly, a water jet cutter may be used.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of producing composite vehicle door panels comprising:
manufacturing a skin in a vacuum-forming mold;
transferring the skin to a RIM mold;
applying natural fiber and an isocyanate and resin mixture onto the skin;
polymerizing the isocyanate and resin mixture, natural fiber, and a skin into a composite vehicle door panel.

2. The method of claim 1 wherein the natural fibers are hemp, kenaf, sisal, flax, or jute.

3. The method of claim 1 further comprising the step of trimming the skin before natural fibers are placed on the skin.

4. The method of claim 1 further comprising the step of trimming the skin after the isocyanate and resin mixture, natural fiber, and the skin have polymerized.

5. The method of claim 1 wherein the natural fibers are provided as rovings.

6. The method of claim 1 wherein the natural fibers are provided as a mat.

7. The method of claim 1 wherein the natural fibers and isocyanate and resin mixture are applied to the skin simultaneously.

8. The method of claim 1 wherein the natural fibers are applied to the skin first and the isocyanate and resin mixture are applied onto the natural fibers.
